(19) United States
(12) Patent Application Publication
(10) Pub. No.: US 2019/0244283 A1
(43) Pub. Date: Aug. 8, 2019

(54) NOTIFICATION PROCESSING APPARATUS, NOTIFICATION PROCESSING METHOD, AND INFORMATION TERMINAL

(71) Applicant: Toyota Jidosha Kabushiki Kaisha, Toyota-shi Aichi-ken (JP)

(72) Inventors: Kazuhiro Umeda, Nisshin-shi Aichi-ken (JP); Takumi Fukunaga, Nisshin-shi Aichi-ken (JP); Makoto Akahane, Nagoya-shi Aichi-ken (JP); Satoshi Usui, Machida-shi Tokyo (JP)

(73) Assignee: Toyota Jidosha Kabushiki Kaisha, Toyota-shi Aichi-ken (JP)

(21) Appl. No.: 16/268,037

(22) Filed: Feb. 5, 2019

(30) Foreign Application Priority Data
Feb. 8, 2018 (JP) 2018-021180

(51) Int. Cl. G06Q 30/06; H04W 4/44; H04L 29/08; G01C 21/36

(52) U.S. Cl. CPC G06Q 30/0645; G01C 21/3697; H04L 67/26; H04W 4/44

(57) ABSTRACT

A notification processing apparatus includes: a calculation unit configured to calculate, based on information on a current location of a user and information on a current location of a first vehicle used by the user, a first required time, calculate, based on the information on the current location of the first vehicle and information on a scheduled return place of the first vehicle, a second required time, and calculate, based on the first required time and the second required time, a movement start time; and a notification processing unit configured to notify the movement start time to the user.

### CROSS-REFERENCE TO RELATED APPLICATION

This application claims priority to Japanese Patent Application No. 2018-021180 filed on Feb. 8, 2018, incorporated herein by reference in its entirety.

### BACKGROUND

### 1. Technical Field

The present disclosure relates to a notification processing apparatus, a notification processing method, and an information terminal.

### 2. Description of Related Art

Japanese Patent Application Publication No. 2004-295392 (JP 2004-295392 A) discloses a technique to display rent-a-car return deadline information on a rent-a-car terminal, when a movement time required for returning the rent-a-car, calculated based on a current location and a return location of the rent-a-car, is larger than the time left before scheduled return date and time.

### SUMMARY

In JP 2004-295392 A, a vehicle is equipped with a rent-a-car terminal that displays return deadline information. Therefore, when a user is away from the rent-a-car vehicle for the sake of, for example, sightseeing, shopping, or other purposes, the user notices the return deadline information only after getting on the vehicle. In such a case, it becomes difficult to return the vehicle by the scheduled return time.

Accordingly, the present disclosure provides a notification processing apparatus, a notification processing method, and an information terminal, capable of encouraging a user to return a vehicle by a scheduled return time even when the user is away from the vehicle.

A notification processing apparatus according to a first aspect of the present disclosure includes: a calculation unit; and a notification processing unit. The calculation unit is configured to calculate, based on information on a current location of a user and information on a current location of a first vehicle used by the user, a first required time required for the user to move from the current location of the user to the first vehicle. The calculation unit is configured to calculate, based on the information on the current location of the first vehicle and information on a scheduled return place of the first vehicle, a second required time required for the first vehicle to travel from the current location of the first vehicle to the scheduled return place of the first vehicle. The calculation unit is configured to calculate, based on the first required time and the second required time, a movement start time required for the user to return the first vehicle to the scheduled return place by a scheduled return time of the first vehicle. The notification processing unit is configured to notify the movement start time to the user.

In the first aspect, the calculation unit may be configured to calculate the second required time based on traffic information, in addition to the information on the current location of the first vehicle and the information on the scheduled return place of the first vehicle.

In the first aspect, the notification processing unit may be configured to notify another user, different from the user of the first vehicle, to return a second vehicle used by the other user to the scheduled return place of the first vehicle by the scheduled return time of the first vehicle, when determining that the user fails to return the first vehicle by the scheduled return time of the first vehicle.

In the first aspect, the notification processing unit may be configured to notify the other user to return the second vehicle, when the notification processing unit determines that the user fails to return the first vehicle by the scheduled return time of the first vehicle, and next reservation of the first vehicle is set within a prescribed time from the scheduled return time of the first vehicle.

The first aspect may include an incentive granting unit to grant an incentive to the other user, when the other user returned the second vehicle to the scheduled return place of the first vehicle by the scheduled return time of the first vehicle.

In the first aspect, the notification processing unit may be configured to notify the other user, using the second vehicle without next reservation, to return the second vehicle within the prescribed time from the scheduled return time of the first vehicle.

In the first aspect, when notifying to return the second vehicle, the notification processing unit is configured to further notify a movement start time to be required for the other user to return the second vehicle.

A notification processing method according to a second aspect of the present disclosure is a notification processing method executed by a processor, the method including: calculating of a first required time; calculating of a second required time; calculating of a movement start time; and notifying of the movement time. The calculating of the first required time calculates, based on information on a current location of a user and information on a current location of a first vehicle used by the user, the first required time required for the user to move from the current location of the user to the first vehicle. The calculating of the second required time calculates, based on the information on the current location of the first vehicle and information on a scheduled return place of the first vehicle, the second required time required for the first vehicle to travel from the current location of the first vehicle to the scheduled return place of the first vehicle. The calculating of the movement time calculates, based on the first required time and the second required time, the movement start time to be required for the user to return the first vehicle to the scheduled return place by a scheduled return time of the first vehicle. The notifying of the movement time notifies the movement start time to the user.

An information terminal according to a third aspect of the present disclosure includes: a transmission unit; and a display unit. The transmission unit is configured to transmit identification information for identifying a user who holds the information terminal, and information on a current location of the information terminal. The display unit is configured to receive and display movement start time information to be required to return a vehicle used by the user to a scheduled return place by a scheduled return time of the vehicle.

The present disclosure can provide a notification processing apparatus, a notification processing method, and an information terminal, capable of encouraging a user to return a vehicle by a scheduled return time even when the user is away from the vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 illustrates the configuration of a notification processing system according to an embodiment;

FIG. 2 is a sequence chart for describing one example of the operation of the notification processing system according to the embodiment;

FIG. 3 is a flowchart for describing one example of the procedure of an alternative vehicle return request process shown in FIG. 2; and

FIG. 4 is a flowchart for describing one example of the procedure of an incentive granting process shown in FIG. 2.

### DETAILED DESCRIPTION

Embodiments of the present disclosure will be described with reference to the accompanying drawings. Furthermore, in each of the drawings, identical or like component members are designated by identical reference signs.

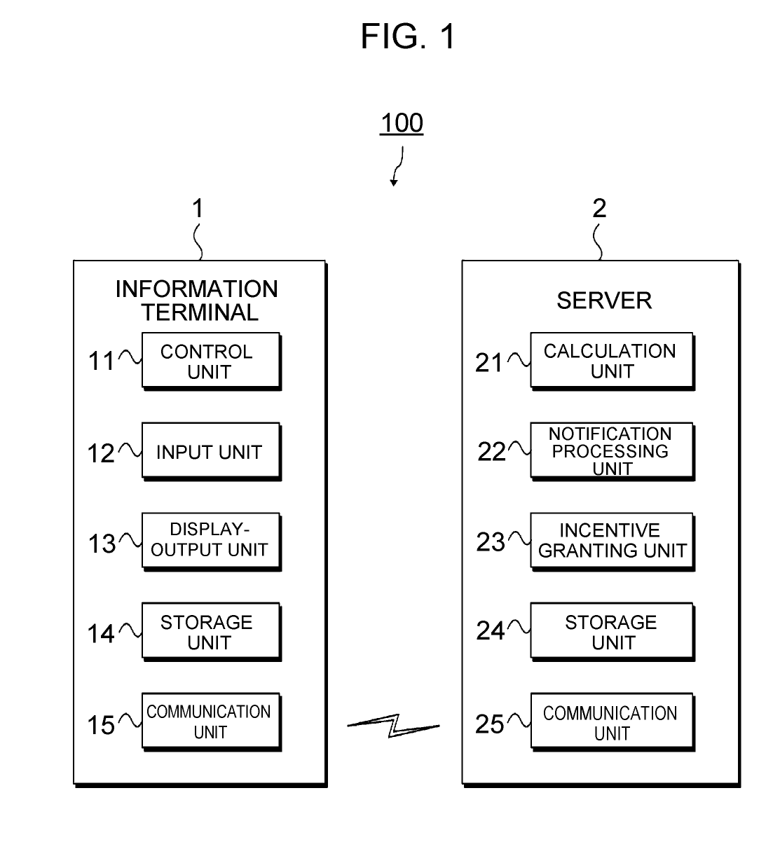

With reference to FIG. 1, the configuration of a notification processing system according to an embodiment will be described. A notification processing system 100 includes, for example, an information terminal 1 held by a user that uses car sharing service, and a server 2 (notification processing apparatus) for managing vehicles subjected to car sharing. The information terminal 1 and the server 2 are configured to be communicable with each other via a network including a radio network, for example.

The information terminal 1 shown in FIG. 1 is a terminal apparatus, such as a smartphone, for example. The information terminal 1 has, for example, a control unit 11, an input unit 12, a display-output unit 13, a storage unit 14, and a communication unit 15 as functional components. The information terminal 1 is configured by including, for example, a control unit including a central processing unit (CPU) and a memory, an operation unit, a display, a speaker, a storage unit, and a communication unit as physical components. When the CPU executes specified programs stored in the memory, each function of the control unit 11, the input unit 12, the display-output unit 13, the storage unit 14, and the communication unit 15 is implemented.

The server 2 has, for example, a calculation unit 21, a notification processing unit 22, an incentive granting unit 23, a storage unit 24, and a communication unit 25 as functional components. The server 2 is configured by including, for example, a control unit including a CPU and a memory, a storage unit, and a communication unit as physical components. When the CPU executes specified programs stored in the memory, each function of the calculation unit 21, the notification processing unit 22, the incentive granting unit 23, the storage unit 24, and the communication unit 25 is implemented.

The server 2 stores and manages vehicle information on each of the vehicles subjected to car sharing in a database or the like. The vehicle information includes, for example, a vehicle ID that identifies a vehicle, information on the current location of the vehicle, and information on the use status of the vehicle. The information on the use status of the vehicle includes, for example, information indicating whether or not the vehicle is in use by a user, a user ID that identifies the user using the vehicle, a use start time, a use start place, a scheduled return time, and a scheduled return place or the like.

The information on the current location of the vehicle and the information on the use status of the vehicle can be collected at any time from an onboard equipment mounted on each of the vehicles and from the information terminal 1 held by the user using each of the vehicles. It should be noted that some or all of the information on the current location of the vehicle and the information on the use status of the vehicle may also be collected at any time from, for example, the server in a data center that manages information on the onboard equipment or the like, instead of from the onboard equipment.

The server 2 collects traffic information including traffic congestion information at any time from, for example, a traffic information center or the like, and stores and manages the collected information in a database or the like.

Among each of the functions of the server 2, the functions of the calculation unit 21, the notification processing unit 22, and the incentive granting unit 23 will be described below in detail.

The calculation unit 21 calculates, based on information on the current location of a user and information on the current location of a vehicle used by the user (hereinafter referred to as “user vehicle (first vehicle)”), a first required time required for the user to move from the current location of the user to the user vehicle.

The information on the current location of the user is identified by information on the current location of the information terminal 1 held by the user. The information on the current location of the information terminal 1, which is the information on the current location of the user, is transmitted from the information terminal 1 of the user who confirmed car allocation in the car sharing service. The current location of the information terminal 1 can be measured using the function of a global positioning system (GPS) mounted on the information terminal 1, for example.

Timing of the information on the current location of the user transmitted from the information terminal 1 may be at a specific time, in a periodic manner, or when the user inputs a specific operation in the car sharing service, for example.

The specific time corresponds to, for example, a use start time of the vehicle. The specific operation includes, for example, an operation to confirm vehicle allocation, an operation to start vehicle use, and an operation to notify the current location or the like.

The operation to confirm vehicle allocation is the operation of the user selecting a desired vehicle out of the vehicles displayed on the information terminal 1 and confirming vehicle allocation. When the user inputs the operation to confirm vehicle allocation, a vehicle allocation request is transmitted from the information terminal 1 to the server 2. The vehicle allocation request includes, for example, a user ID of the user who uses a user vehicle, a vehicle ID of the user vehicle, a scheduled return time of the user vehicle, and a scheduled return place of the user vehicle. The information on the current location of the user may also be included in the vehicle allocation request.

The means of transportation of the user from the current location of the user to the user vehicle may be walking only, or may also be using transportation facilities, or the like. For example, the user may set the movement means in advance or every time the user uses the service, or the calculation unit 21 may also select the means that can provide the shortest route to the vehicle.

The calculation unit 21 calculates, based on the information on the current location of the user vehicle, the information on a scheduled return place of the user vehicle, and the traffic information, a second required time required for the user vehicle to travel from the current location of the user vehicle to the scheduled return place.

Exemplarily, the second required time in the case where the current location of the user vehicle is point A and the scheduled return place of the user vehicle is point B will be described. When the normal required time of the vehicle is one hour from point A to point B, and a total delay time of 45 minutes is expected due to a plurality of congested areas present on the route from point A to point B, the second required time from point A to point B becomes one hour and 45 minutes. Thus, the calculation unit 21 can calculate the second required time in consideration of the delay time due to traffic congestion.

The calculation unit 21 calculates, based on the first required time and the second required time, a movement start time required to return the user vehicle by the scheduled return time of the user vehicle.

Exemplarily, in the case where the first required time is 15 minutes, the second required time is one hour and 45 minutes, and the scheduled return time is 18:00, the movement start time becomes 16:00.

The notification processing unit 22 notifies the movement start time to the user by transmitting movement start time information including the movement start time to the information terminal 1. The notification to the user is performed by, for example, displaying a message including the movement start time on the display of the information terminal 1 held by the user, or by outputting a voice from a speaker of the information terminal 1.

The notification processing unit 22 executes an alternative vehicle return request process. The contents of the alternative vehicle return request process will be described below.

The notification processing unit 22 executes return propriety determination that determines whether or not a user can return a user vehicle by the scheduled return time of the user vehicle. The return propriety determination may also be executed only when next reservation is set for the user vehicle. This is because extending the scheduled return time does not affect the next reservation if the user vehicle does not have the next reservation.

On the contrary, even in the case of the user vehicle having next reservation, it is also considered that extending the scheduled return time may not affect the next reservation if there is enough time until the next reservation. In consideration of such a case, the return propriety determination may be executed only when next reservation of the user vehicle is set within a prescribed time from the scheduled return time of the user vehicle. The prescribed time can suitably be set in consideration of the time necessary to be secured by the next reservation.

When determining that the user fails to return the user vehicle by the scheduled return time of the user vehicle, the notification processing unit 22 notifies a request message to another user, different from the user of the user vehicle, to request return of a vehicle (hereinafter also referred to as “another user vehicle (second vehicle)” used by the other user to the scheduled return place of the user vehicle by the scheduled return time of the user vehicle. The notification to the other user is performed by, for example, displaying the request message on the display of the information terminal 1 held by the other user, or by outputting a voice from the speaker of the information terminal 1 of the other user.

The notification processing unit 22 may determine that the user fails to return the user vehicle by the scheduled return time of the user vehicle as described below, for example. First, the calculation unit 21 repeatedly calculates the first required time and the second required time and, at the same time, calculates an estimated time when the user vehicle is returned. The notification processing unit 22 determines that the user fails to return the user vehicle by the scheduled return time of the user vehicle, when a difference between the estimated return time and the scheduled return time of the user vehicle exceeds a prescribed time.

The request message may preferably be notified only to another or other users corresponding to another or other vehicles without next reservation. This is because failing to return another or other vehicles having next reservation to the scheduled return place of the other or other user vehicles may affect the next reservation.

However, even in the case of another user vehicle having next reservation, the request message may be notified to another user corresponding to the other user vehicle without problems, if there is an enough time until the next reservation. In consideration of such a case, the request message may be notified to another user corresponding to another user vehicle without next reservation within a prescribed time from the scheduled return time of the user vehicle. The prescribed time can suitably be set in consideration of the time necessary to be secured by the next reservation.

The request message may include a movement start time required for another user to return the other user vehicle. The movement start time may be calculated in a similar manner as the movement start time corresponding to the user vehicle described before. Therefore, description of the calculation method is omitted herein.

It should be noted that the other user whose movement start time has already passed may be excluded from notification targets of the request messages. This is because the other user whose movement start time has already passed is less likely to arrive at the scheduled return place of the user vehicle by the scheduled return time of the user vehicle.

Additionally, the request message notified to the other user may include the contents of an incentive granted to the other user in return for returning the other user vehicle in compliance with the request message. Including the contents of the incentive in the message can motivate the other user to meet the request message.

The incentive granting unit 23 executes an incentive granting process. Hereinafter, the contents of the incentive granting process will be described.

The incentive granting unit 23 grants an incentive to another user, when the other user returns the other user vehicle to the scheduled return place of the user vehicle by the scheduled return time of the user vehicle.

For example, the incentive includes various rewards, such as coupons, discount tickets, points, courtesy services and goods which are usable in the car sharing service.

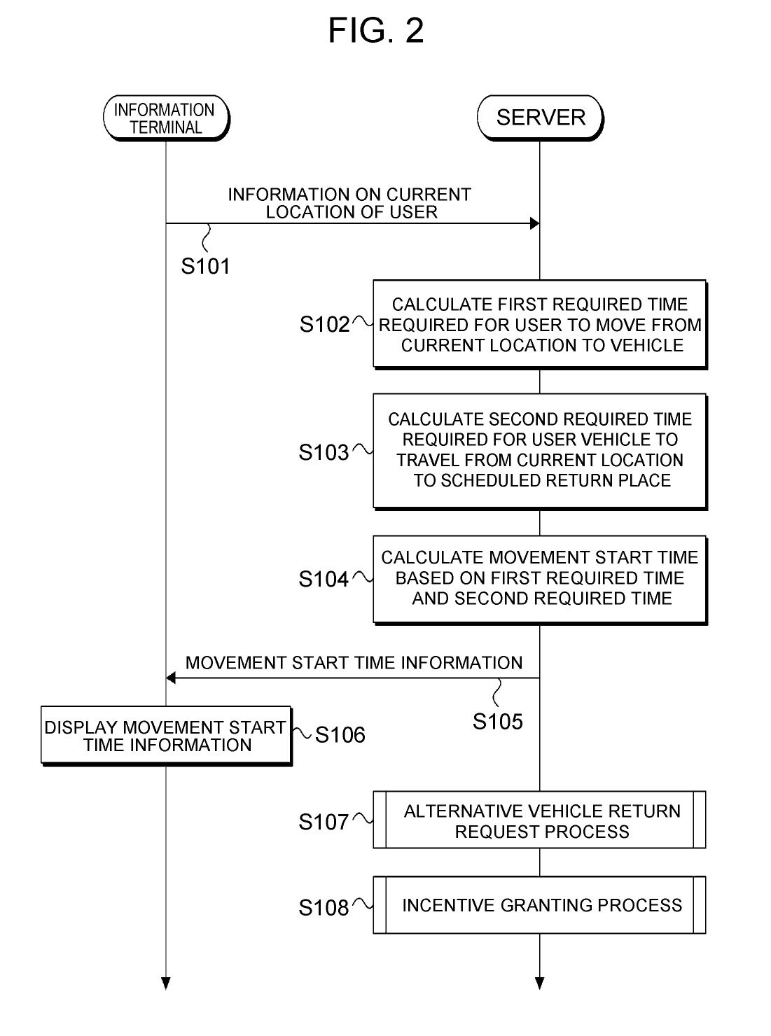

With reference to FIG. 2, one example of the operation of the notification processing system 100 in the embodiment will be described.

It is supposed that before the operation of the notification processing system 100, the information terminal 1 transmits a vehicle allocation request to the server 2. The vehicle allocation request is transmitted from the information terminal 1, when a user operates the information terminal 1, selects a desired user vehicle, and inputs the vehicle allocation confirmation operation. Upon reception of the vehicle allocation request, the server 2 acquires a user ID of the user who uses a user vehicle, a vehicle ID of the user vehicle, a scheduled return time of the user vehicle, and a scheduled return place of the user vehicle.

First, when the use start time of the user vehicle has come, for example, the information terminal 1 transmits information on the current location of the information terminal 1 to the server 2 as the information on the current location of the user (step S101). It should be noted that the process of the step S101 (including the process subsequent to step S101) is repeatedly executed in every prescribed time even after the use start time. The prescribed time may be set to any time.

Next, the calculation unit 21 of the server 2 calculates, based on the information on the current location of the user vehicle corresponding to the vehicle allocation request received from the information terminal 1, and the information on the current location of the user received in the step S101, a first required time required for the user to move from the current location of the user to the user vehicle (step S102).

Next, the calculation unit 21 of the server 2 calculates, based on the information on the current location of the user vehicle corresponding to the vehicle allocation request received from the information terminal 1 and information on the scheduled return place of the user vehicle, and traffic information, a second required time required for the user vehicle to travel from the current location of the user vehicle to a scheduled return place, (step S103).

Next, the calculation unit 21 of the server 2 calculates, based on the first required time calculated in the step S102, the second required time calculated in the step S103, and the scheduled return time of the user vehicle, a movement start time required to return the user vehicle by the scheduled return time (step S104).

Next, the notification processing unit 22 of the server 2 transmits the movement start time information to the information terminal 1 (step S105).

Next, the information terminal 1 displays the movement start time information on a display (step S106).

Next, the notification processing unit 22 of the server 2 executes an alternative vehicle return request process (step S107), and executes an incentive granting process (step S108).

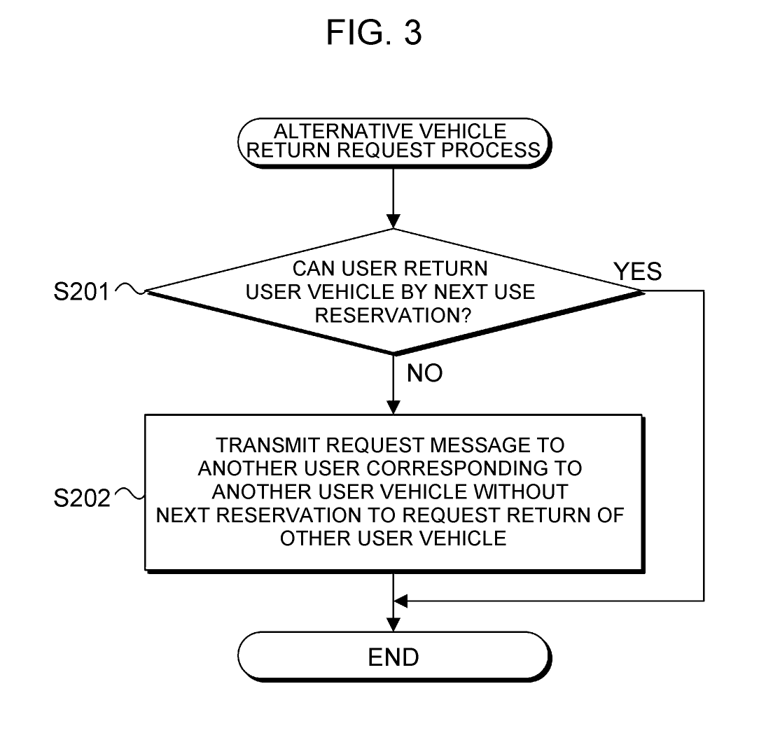

With reference to FIG. 3, description will be given of one example of the procedure of the alternative vehicle return request process executed in the step S107.

First, the notification processing unit 22 of the server 2 determines whether or not the user can return the user vehicle by the scheduled return time of the user vehicle (step S201). When the determination result is YES (step S201; YES), the alternative vehicle return request process is ended.

On the contrary, when determining that the user fails to return the user vehicle by the scheduled return time of the user vehicle in the step S201 (step S201; NO), the notification processing unit 22 of the server 2 notifies a request message to the information terminal 1 held by another user corresponding to another user vehicle without next reservation to request return of the other user vehicle to the scheduled return place of the user vehicle by the scheduled return time of the user vehicle (step S202). Thus, the alternative vehicle return request process is ended.

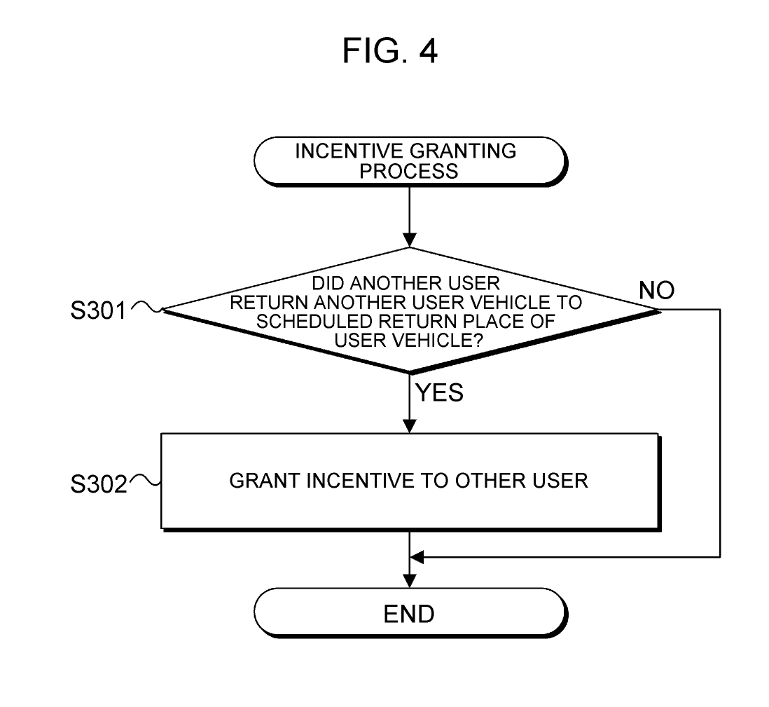

With reference to FIG. 4, description is given of one example of the procedure of the incentive granting process executed in the step S108.

First, the incentive granting unit 23 of the server 2 determines whether or not the other user returned the other user vehicle to the scheduled return place of the user vehicle by the scheduled return time of the user vehicle (step S301). When the determination result is NO (step S301; NO), the incentive granting process is ended.

However, when determining in the step S301 that the other user returned the other user vehicle to the scheduled return place of the user vehicle (step S301; YES), the incentive granting unit 23 of the server 2 grants an incentive to the other user (step S302).

As described in the foregoing, in the notification processing system 100 in the embodiment, the server 2 may include the calculation unit 21 and the notification processing unit 22. The calculation unit 21 calculates, based on information on the current location of a user and information on the current location of a user vehicle used by the user, a first required time required for the user to move from the current location of the user to the user vehicle. The calculation unit 21 calculates, based on the information on the current location of the user vehicle, the information on a scheduled return place of the user vehicle, and traffic information, a second required time required for the user vehicle to travel from the current location of the user vehicle to the scheduled return place. The calculation unit 21 calculates, based on the first required time and the second required time, a movement start time required for the user to return the user vehicle to the scheduled return place by the scheduled return time of the user vehicle. The notification processing unit 22 notifies the movement start time to the user.

Thus, even in the case where the user who uses a vehicle subjected to car sharing is away from the user vehicle, it becomes possible to calculate the movement start time in consideration of the time to move to the user vehicle or the delay time caused by traffic congestion, and to notify the movement start time to the information terminal 1 held by the user.

Therefore, the notification processing system 100 in the embodiment can encourage the user to return the user vehicle to the scheduled return place by the scheduled return time even when the user is away from the user vehicle.

### Modification

It should be noted that the present disclosure is not limited to the embodiments disclosed, but may be performed in other various forms without departing from the scope of the present disclosure. Therefore, the embodiments disclosed are in all respects illustrative and are not considered as the basis for restrictive interpretation. For example, the order of each of the process steps described before may optionally be changed or executed in parallel without producing inconsistency in the contents of the process.

Additionally, in the embodiments disclosed, when the notification processing unit 22 notifies a request message to another or other users, the priority of the other users is calculated, and the request message may also be notified to the other users in a descending order of priority. Calculation of the priority can be performed based on the rules, such as a) the priority is higher as the possibility of being able to return the other user vehicle to the scheduled return place by the scheduled return time of the user vehicle is higher, and b) the priority is higher as the use start time of the other user vehicle is closer to the movement start time. The possibility of returning can be calculated based on, for example, the travel distance or the movement time of the other user vehicle.

Additionally, the component members of the information terminal 1 and the server 2 are not limited to the component members in the embodiments disclosed. Any component members may suitably be added where necessary.

What is claimed is:

1. A notification processing apparatus, comprising:
a calculation unit configured to
calculate, based on information on a current location of a user and information on a current location of a first vehicle used by the user, a first required time required for the user to move from the current location of the user to the first vehicle,
calculate, based on the information on the current location of the first vehicle and information on a scheduled return place of the first vehicle, a second required time required for the first vehicle to travel from the current location of the first vehicle to the scheduled return place of the first vehicle, and
calculate, based on the first required time and the second required time, a movement start time required for the user to return the first vehicle to the scheduled return place by a scheduled return time of the first vehicle; and
a notification processing unit configured to notify the movement start time to the user.

2. The notification processing apparatus according to claim 1, wherein
the calculation unit is configured to calculate the second required time based on traffic information, in addition to the information on the current location of the first vehicle and the information on the scheduled return place of the first vehicle.

3. The notification processing apparatus according to claim 1, wherein
the notification processing unit is configured to notify another user, different from the user of the first vehicle, to return a second vehicle used by the other user to the scheduled return place of the first vehicle by the scheduled return time of the first vehicle, when determining that the user fails to return the first vehicle by the scheduled return time of the first vehicle.

4. The notification processing apparatus according to claim 3, wherein
the notification processing unit is configured to notify the other user to return the second vehicle, when the notification processing unit determines that the user fails to return the first vehicle by the scheduled return time of the first vehicle, and next reservation of the first vehicle is set within a prescribed time from the scheduled return time of the first vehicle.

5. The notification processing apparatus according to claim 3, further comprising an incentive granting unit configured to grant an incentive to the other user, when the other user returned the second vehicle to the scheduled return place of the first vehicle by the scheduled return time of the first vehicle.

6. The notification processing apparatus according to claim 3, wherein the notification processing unit is configured to notify the other user who uses the second vehicle without next reservation to return the second vehicle within a prescribed time from the scheduled return time of the first vehicle.

7. The notification processing apparatus according to claim 3, wherein when notifying to return the second vehicle, the notification processing unit is configured to further notify a movement start time to be required for the other user to return the second vehicle.

8. A notification processing method executed by a processor, comprising:
calculating, based on information on a current location of a user and information on a current location of a first vehicle used by the user, a first required time required for the user to move from the current location of the user to the first vehicle;
calculating, based on the information on the current location of the first vehicle and information on a scheduled return place of the first vehicle, a second required time required for the first vehicle to travel from the current location of the first vehicle to the scheduled return place of the first vehicle;
calculating, based on the first required time and the second required time, a movement start time to be required for the user to return the first vehicle to the scheduled return place by a scheduled return time of the first vehicle; and
notifying the movement start time to the user.

9. An information terminal, comprising:
a transmission unit configured to transmit identification information for identifying a user who holds the information terminal, and information on a current location of the information terminal; and
a display unit configured to receive and display movement start time information to be required to return a vehicle used by the user to a scheduled return place by a scheduled return time of the vehicle.
